(19) United States
(12) Patent Application Publication
(10) Pub. No.: US 2024/0385825 A1
(43) Pub. Date: Nov. 21, 2024

(54) TECHNIQUES FOR AUTOMATED PROCESSING OF COMPUTATIONAL TASKS

(71) Applicant: Setuply, Inc., Portsmouth, NH (US)

(72) Inventors: Daniil Fishteyn, Portsmouth, NH (US); Dmitry Korsunsky, Portsmouth, NH (US); Kelly Blackledge, Florham Park, NJ (US); Rachel Lyubovitzky, Portsmouth, NH (US)

(73) Assignee: Setuply, Inc., Portsmouth, NH (US)

(21) Appl. No.: 18/668,037

(22) Filed: May 17, 2024

Related U.S. Application Data
(60) Provisional application No. 63/503,100, filed on May 18, 2023.

(51) Int. Cl. G06F 9/48; G06F 21/62

(52) U.S. Cl. CPC G06F 8/65; G06Q 10/06316

(57) ABSTRACT

This disclosure describes techniques for executing operations associated with a computational task based on a context associated with the task. The context may represent at least one of: (i) a data field that an example system needs to automatically execute the task associated with the task or (ii) a system state that the example system needs to trigger to automatically execute the task associated with the task. In some examples, the example system updates the context over time and based on execution outcomes associated with prior executions of the task or similar tasks. For example, if the prior execution outcomes illustrate that those executions have failed to provide a required data field, the example system may update the context associated with the task to identify the missing data field. Accordingly, in some examples, the techniques described herein enable dynamically updating task contexts over time and based on past execution outcomes.

### BACKGROUND

Conventional task execution systems often require manual intervention and lack the ability to adapt to changing requirements. Many such conventional systems rely on static configurations, which can result in inefficient task execution, increased manual effort, and limited adaptability to evolving task conditions. Therefore, there exists a need for an improved task execution system and method that addresses the limitations of conventional approaches.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 provides an example architecture illustrating the components and interactions of a contextual execution system.

FIG. 2 is a flowchart diagram of an example process for determining whether to update a context associated with a task type.

FIG. 3 is a flowchart diagram of an example process for contextual execution of a computational task.

FIG. 4 provides an operational example of a data form creation platform that has been used to create a data entry form.

FIG. 5 provides an operation example of a task creation platform that can be used to receive an execution request from a user and identify the task type for the received request.

FIG. 6 provides an operational example of a data entry platform that enables a user to provide values corresponding to automation parameters of an execution task associated with distribution of an address change request form.

FIG. 7 is a flowchart diagram of an example process for dynamically updating context of an execution request over time.

FIG. 8 illustrates example computing device(s) for performing techniques described herein.

### DETAILED DESCRIPTION

This disclosure describes techniques for executing operations associated with a computational task based on a context associated with the task. The context may represent at least one of: (i) one or more data fields that an example system needs to provide to automatically execute the task associated with the task, or (ii) one or more system states that the example system can trigger to automatically execute the task associated with the task. In some examples, the example system updates the context over time and based on execution outcomes associated with prior executions of the task or similar tasks. For example, if the prior execution outcomes illustrate that those executions have failed to provide a required data field, the example system may update the context associated with the task to identify the missing data field. Accordingly, in some examples, the techniques described herein enable dynamically updating task contexts over time and based on past outcomes. By dynamically updating task contexts (e.g., with missing required data fields, missing required system states, etc.), the example system can improve its ability to autonomously execute tasks and adapt to changing requirements. This adaptive behavior enhances the overall efficiency and effectiveness of the system in automating various operations.

For example, the example system may receive a task associated with distributing a monthly newsletter to a group of subscribers. After receiving the task, the system may determine that the context associated with the corresponding “newsletter distribution” task type identifies a recipient list and an email template. The system may then obtain the recipient list and the email template and attempt to execute the task corresponding to the request. During the execution, the system may attempt to send the newsletters using the provided recipient list and email template. However, the system may determine that the execution fails because execution data fails to include Simple Mail Transfer Protocol (SMTP) server configuration data for the relevant email server. To address this execution failure, the system may dynamically update the context associated with the “newsletter distribution” task type to identify the SMTP server configuration data. In some examples, by updating the context with the “newsletter distribution” task type to identify the SMTP server configuration data, the system ensures that future execution attempts for newsletter distribution will include the necessary SMTP server configuration data. This adaptive behavior allows the system to learn from and rectify execution failures automatically.

As another example, the example system may receive a task associated with processing an online order and generating a shipping label for the online order. After receiving the task, the system may determine that the context associated with the corresponding “order processing” task type identifies order data and warehouse inventory management data. During the execution, the system may process the order using the provided order data. However, the system may determine that the execution fails because execution data fails to include an integration with a relevant shipping carrier platform and an integration with a relevant warehouse inventory management platform. To address the execution failure, the system may dynamically update the context associated with the “order processing” task type to identify a first required operational state associated with successful integration with the relevant shipping carrier platform and a second required operational associated with successful integration with the relevant warehouse inventory management platform. In some examples, by updating the context associated with the “order processing” task type to identify the two required operational states, the system ensures that future execution attempts for order processing and label generation will include the required integrations with the relevant shipping carrier platform and the relevant warehouse inventory management platform.

In some examples, the techniques described herein include determining a task type associated with a received execution request. In some examples, an example system receives an execution request that identifies an associated task type. For example, the example system may receive a request to distribute a data entry form related to change of address to a set of recipients. In this example, the example system may associate the request with a task type that represents a request to distribute the address change form.

In some examples, an execution request includes a specific instruction or command submitted to the example system that indicates a request to execute the task associated with a computational task. The execution request may identify relevant data needed for the system to execute the requested task accurately and efficiently.

Examples of execution requests include an execution request for placing an order for a product, an execution request for generating a data reporting, an execution request for extracting data from a database, an execution request for initiating a scheduled backup process, an execution request for performing system one or more maintenance tasks, and an execution request for launching one or more software tests.

In some examples, a task type represents a category of execution requests that have shared requirements (e.g., a shared set of required data fields, a shared set of required system states, and/or the like). In some examples, execution tasks associated with a common task type have a common set of requirements, a common set of software operations, a common set of computing platforms, a common set of databases, and/or a common set of application programming interfaces (APIs). For example, execution requests associated with a “data import” task type may all require specific data fields like file name, data format, and target destination. As another example, execution requests associated with a “payment processing” task type may all require authentication data, transaction details, and integration with payment gateways. As yet another example, execution requests associated with a “report generation” task type may all require execution of specific software operations such as data retrieval, processing, and formatting operations. These described tasks might utilize the same computing platform, database access, and specific APIs to retrieve the necessary data and generate the desired reports. In some examples, by grouping execution requests into task types, the example system can efficiently handle similar tasks with shared requirements, utilizing common resources and standardized processes. This approach enhances productivity, promotes reusability, and simplifies the management of various tasks within the system.

In some examples, the techniques described herein include determining a context associated with a received execution request. In some examples, after receiving the execution request, the example system may retrieve a context associated with the task type corresponding to received request. In some examples, the context associated with an execution task represents one or more requirements associated with automatic execution of task. In some examples, the example system can use the execution request associated with a request to determine the specific requirements and dependencies associated with an execution request, enabling the system to retrieve the required data, perform the necessary operations, and make intelligent determinations throughout the task execution process. For example, the context associated with an execution request with a “shipment tracking” task type may identify the tracking number, carrier information, and delivery status. In some examples, this context allows the system that executes the task corresponding to the “shipment tracking” task type to monitor and provide accurate updates on the shipment's progress. As another example, the context associated with an execution request with a “document approval process” task type may include the document requiring approval, the designated approvers, and any associated deadlines or rules. In some examples, this context allows the system that executes the task corresponding to the “document approval process” task type to route the document to the designated approvers and enforce the necessary approval criteria.

In some examples, the context associated with an execution request may identify one or more automation parameters associated with the request. An automation parameter May identify a data field or a system state needed before the system can successfully execute the task associated with the request in an automated way and without manual intervention. For example, an automation parameter may represent that, to execute the task associated with an execution request with a task type that represents a request to distribute an address change form, the example system needs to obtain data identifying at least one of a set of distribution recipients or authentication data needed to access a data platform that contains the address platform. As another example, an automation parameter may represent that, to execute the task associated with an execution request with a task type that represents a request to distribute an address change form, the example system needs to ensure that the system successfully connects to a virtual private network. As these examples illustrate, in some examples, the system may determine the context associated with a received request based on the context associated with a task type of the received request.

In some examples, an automation parameter identifies a specific data field, system state, or condition required for the successful execution of a task in an automated manner, without manual intervention. In some examples, automation parameters represent inputs or prerequisites for the automated execution of tasks, ensuring that the system has access to necessary data or satisfies necessary conditions before commencing execution. For example, an automation parameter for an execution request associated with an “email marketing” task type may identify the list of email addresses to send a particular campaign to, as the example system needs this parameter to automatically distribute the emails to the correct recipients. As another example, an execution request for an execution request that includes accessing a secure platform may include authentication data (e.g., usernames, passwords, or API keys) needed to automatically authenticate and retrieve data from the secure platform. I

Examples of automation parameters include an automation parameter that defines data access platform for a data retrieval operation associated with an execution second task, an automation parameter that defines an access credential for accessing the data access platform, an automation parameter that defines an automated operation associated with an execution task, an automation parameter that defines an execution agent (e.g., an employee) for executing a manual task associated with an execution task, and an automation parameter that defines a failsafe operation to execute subsequent to detecting failure of an automated operation associated with an execution task.

In some examples, automation parameter defines at least one of: (i) a first feature associated with a data retrieval operation for the corresponding task type, or (ii) a second feature associated with a post-retrieval operation for the corresponding task typ. For example, consider a task type related to generating reports from a database. The first automation parameter could identify the specific data fields required for the data retrieval operation, such as customer names, purchase dates, and product quantities. This first automation parameter may ensure that the system retrieves the necessary data from the database to generate the desired reports accurately. The second automation parameter, in this example, may identify a post-retrieval operation, such as performing data aggregation or applying specific formatting to the retrieved data. This second automation parameter may define the aggregation method to be used or the formatting rules to be applied, ensuring that the generated reports are presented in the desired format and with the required level of summarization or detail.

In some examples, the techniques described herein include generating a data retrieval request to retrieve and/or obtain data required to satisfy requirements identified by the context associated with an execution request. In some examples, after retrieving the context associated with the execution request, the example system may obtain data needed to satisfy the requirements of the automation parameters identified by the context. Obtaining a data field may include at least one of: (i) providing a query to an end user and determining the data field based on a query response provided by the end user, or (ii) retrieving task data associated with the execution request and determine the data field based on the retrieved task data.

For example, if an automation parameter identified by the context associated with a request requires access to a data field before automatic execution of the request, the system may obtain the data field using at least one of a query provided to requesting user or task data stored in a storage device associated with the system. As another example, if an automation parameter identified by the context associated with a request requires triggering of a system state, the example system may obtain data needed to perform operations needed to trigger the system state and then perform those operations configured to obtain the trigger the system based on the obtained data.

In some examples, by obtaining the data needed to satisfy the requirements of the automation parameters identified in the context, the example system ensures that the system has access to the necessary inputs to successfully carry out the automated operations. This may enable efficient and streamlined execution of tasks, minimizing errors and reducing the need for manual intervention.

In some examples, the example system obtains a value associated with an automation parameter using a query provided to a requesting user. In some examples, this approach allows the system to directly communicate with the user to gather the required information or data fields necessary for task execution.

In some examples, when the system identifies an automation parameter that requires specific data from the user, the system formulates a query, often in the form of a prompt or a set of questions. The system may then present the query to the user, who can provide the relevant information needed to satisfy the parameter's requirements. For example, if an automation parameter requires the recipient's email addresses for an email campaign, the system may generate a query asking the user to input the email addresses of the intended recipients. The user can then respond by entering the required data.

In some examples, the example system determines a value associated with an automation parameter based on task data associated with a corresponding execution request and/or task data associated with the task type of the corresponding execution request. In some examples, after the system receives an execution request, the system examines the task data associated with the request to identify relevant information that can satisfy the automation parameters. The task data may contain details related to the task, such as customer information, product specifications, or any other relevant data fields.

For example, if an automation parameter requires the product quantity for order fulfillment, the system can extract this information from the task data provided in the execution request. By analyzing the task data, the system can retrieve the product quantity and utilize the retrieved product quantity to satisfy the requirement of the automation parameter. Similarly, if an automation parameter requires customer authentication data, such as a unique customer identifier, the system can extract this information from the task data associated with the execution request. The system can then use the retrieved customer identifier to authenticate the user without explicitly requesting the customer identifier from the user.

In some examples, task data associated with an execution request include data retrieved from a database based on one or more identifiers of one or more entities associated with the execution request. For example, to determine task data associated with an execution request that relates to processing an online order, the example system may query a database based on an order identifier and/or a product identifier associated with the request.

In some examples, task data associated with a request includes data recorded during past executions of the request and/or past executions of requests pertaining to one or more entities associated with the execution request. In some examples, after executing a request, the system captures and records relevant task data, which may include inputs, outputs, intermediate results, and any other pertinent information associated with the request. In some examples, the system stores the task data on a suitable storage system for future retrieval. By retaining task data from previous executions, the system can leverage this information to enhance efficiency and accuracy in subsequent executions. In some examples, the system can utilize the stored data to avoid redundant computations, customize configurations based on previous settings, and/or provide better recommendations based on historical patterns.

In some examples, the techniques described herein include updating the context associated with a task type based on the execution outcome of an execution request characterized by the task type. In some examples, after obtaining data needed to satisfy the requirements of the automation parameters identified by the context, the example system may execute the task associated with the request to determine an execution outcome. In some examples, if the execution outcome represents that the execution failed due to absence of an automation parameter, the example system may update the context associated with the request to add the automation parameter to the set of parameters identified by the context.

For example, if the execution outcome indicates that the execution of the task corresponding to a request failed due to absence of secondary authentication data (e.g., a two-factor authentication token), the system may update the context associated with the request to add an automation parameter that represents the secondary authentication data. As another example, if the execution outcome indicates that the execution of the task corresponding to a request failed due to absence of connection to a virtual private network, the system may update the context associated with the request to add an automation parameter that represents the operational state associated with connection to the virtual private network.

In some examples, after obtaining the necessary data corresponding to automation parameters identified in a context, the example system proceeds to execute the task associated with the corresponding execution request. The execution outcome may reflect the result of the execution operations and provide insights into the success or failure of those operations. In some examples, if the execution outcome indicates a failure due to the absence of an automation parameter, the example system takes corrective action by updating the context. By adding the missing automation parameter to the set of parameters identified by the context, the system may ensure that future execution attempts account for the previously missing parameter, thus preventing the same failure from occurring again.

For example, if the execution outcome reveals that execution of the task associated with a database retrieval request failed because of the absence of authentication data associated with the target database, the example system may update the context associated with a database retrieval task type to reflect the database authentication data. In some examples, this context update may cause future database retrieval executions to provide the database authentication data, thus decreasing the likelihood of failure of those operations.

As another example, if the execution outcome reveals that execution of the task associated with a database retrieval request failed because of the absence of connection to a virtual private connection associated with the target database, the example system may update the context associated with a database retrieval task type to reflect the connection requirement. In some examples, this context update may cause future database retrieval executions to ensure connection to the virtual private network associated with the target database, thus decreasing the likelihood of failure of those operations.

As yet another example, if the execution outcome reveals that execution of the task associated with a database retrieval request failed because of the absence of a prerequisite condition associated with execution of the request, the example system may update the context associated with a data retrieval task type to reflect the prerequisite requirement.

In some examples, by continually updating contexts associated with a task type based on execution outcomes associated with execution requests having the task type, the system continually improves the system's ability to autonomously execute tasks, and learns from past failures, thereby increasing efficiency and reducing the need for manual intervention for task execution. In some examples, this context update may cause future database retrieval executions to ensure satisfaction of the prerequisite condition, thus decreasing the likelihood of failure of those operations.

In some examples, the execution outcome indicates a post-retrieval processing requirement associated with the execution task. The post-retrieval processing requirement may define at least one of a format modification requirement or a data validation requirement. In some examples, the example system may update the context associated with the corresponding execution request to indicate the post-retrieval processing requirement.

For example, upon retrieving data from a database, the system may determine that a format modification is required to standardize the data format for further processing. Alternatively, the system may identify a data validation requirement to ensure the accuracy and integrity of the retrieved data. Upon identifying such a post-retrieval processing requirement, the example system updates the context associated with the corresponding execution request to indicate the specific requirement. This ensures that subsequent tasks and operations are performed based on the updated context, incorporating the necessary post-retrieval processing to meet the specified requirements.

In some examples, the context update operations described herein play a crucial role in enabling the execution system to determine changing requirements of other systems with which the execution system interacts. By updating the context based on the execution outcome, the system may identify missing automation parameters and incorporate them into subsequent execution attempts. This adaptive behavior allows the execution system to respond to changing requirements (e.g., changing authentication requirements, etc.) imposed by external systems that interact with the execution system interacts.

In an example scenario, an execution request involves accessing a third-party system that requires authentication. Initially, the execution may fail due to the absence of a first authentication credential. The system captures this failure and updates the context by adding an indication of the missing authentication credential. Now, if the external system changes its authentication requirements by adding an additional layer of security or switching to a different authentication method, the context update operations enable the execution system to recognize this change. The system can then modify the automation parameters accordingly, incorporating the updated authentication requirements into the context. This dynamic adaptation allows the execution system to stay aligned with evolving requirements, ensuring smooth and uninterrupted interactions with other systems. By updating the context, the system can detect and accommodate changing authentication requirements, thereby enhancing its ability to integrate with external systems seamlessly.

Accordingly, in some examples, the context update operations described herein enable the execution system to monitor and respond to changing requirements of other systems it interacts with. By capturing and incorporating necessary updates, such as changing authentication requirements, into the context, the system can maintain compatibility and adaptability, ensuring continued successful execution of tasks in evolving environments.

In some examples, the techniques described herein improve computational efficiency of automation systems by reducing the need for manual reconfiguration of automation parameters associated with those systems. As described above, in some examples, the techniques described herein enable dynamically updating task contexts over time and based on past outcomes. By dynamically updating task contexts (e.g., with missing required data fields or missing required system states), an example system can improve its ability to autonomously execute tasks and adapt to changing requirements. This adaptive behavior enhances the overall efficiency and effectiveness of the system in automating various operations.

In some examples, the techniques described herein increase the speed of executing computational tasks by automating operations and minimizing the need for manual intervention. By retrieving context and automation parameters, an example system can autonomously carry out tasks, reducing processing time and human effort. This computational efficiency leads to faster task completion, enabling the system to handle a larger volume of requests within a given time frame.

In some examples, the techniques described herein enable more efficient utilization of system resources. By leveraging context and automation parameters, the system ensures that only the necessary resources are allocated for task execution. This approach reduces usage of computational resources by obtaining data specifically tailored to the task requirements and executing operations with the optimal set of parameters. This resource usage efficiency results in improved performance and reduces the strain on computational resources.

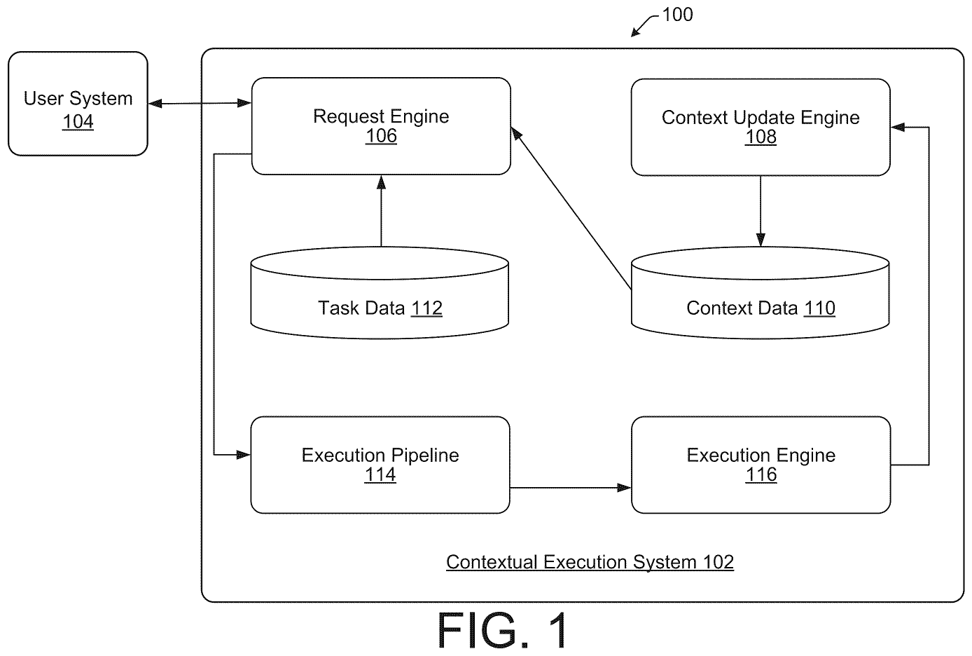

FIG. 1 provides an example architecture 100 illustrating the components and interactions of a contextual execution system 102. As depicted in FIG. 1, the architecture 100 includes a user system 104 that generates execution requests and provides the requests to the contextual execution system 102. The components of the contextual execution system 102 include a request engine 106, a context update engine 108, context data 110, task data 112, an execution pipeline 114, and an execution engine 116.

The request engine 106 may receive an execution request from the user system 104, retrieve the context associated with the received request (e.g., the context associated with the corresponding task type) from the context data 110, and identify one or more automation parameters associated with the request based on the retrieved context. The request engine 106 may determine values associated with the identified automation parameters based on either the task data 112 or responses to queries provided to the user system 104. The request engine 106 may store the execution request along with the determined parameter values on the execution pipeline 114 for further processing.

The execution engine 116 may retrieve the execution request from the execution pipeline 114 and perform the necessary operations to execute the execution request. After executing the task corresponding to the retrieved execution request, the execution engine 116 may determine an execution outcome based on the results of the operations and provide the execution outcome to the context update engine 108 for further processing. The execution outcome may reflect the result of the execution operations and provide valuable insights into the success or failure of those operations.

The context update engine 108 may determine whether the execution outcome indicates a missing automation parameter and, if so, update the context data 110 to add the missing automation parameter. In some examples, context update engine 108 updates the context data 110 based on the missing parameters identified by the execution outcomes. In some examples, the context update engine 108 ensures that the context associated with the execution request remains up-to-date and incorporates any new automation parameters required for future execution attempts.

For example, if the execution outcome reveals that execution of the task associated with a database retrieval request failed because of the absence of authentication data associated with the target database, the context update engine 108 may update the context associated with a database retrieval task type to reflect the database authentication data. As another example, if the execution outcome reveals that execution of the task associated with a database retrieval request failed because of the absence of connection to a virtual private connection associated with the target database, the context update engine 108 may update the context associated with a database retrieval task type to reflect the connection requirement. In some examples, by continually updating contexts associated with a task type based on execution outcomes associated with execution requests having the task type, the context update engine 108 continually improves the system's ability to autonomously execute tasks, and learns from past failures, thereby increasing efficiency and reducing the need for manual intervention.

In some examples, each component of the architecture 100 can be implemented using various techniques. For example, the request engine 106 and execution engine 116 may be implemented as software modules or services within the contextual execution system 102. The context data 110 and task data 112 can be stored using one or more databases and on one or more suitable storage systems. The execution pipeline 114 can be implemented as a queue or other data structure that manages the flow of execution requests.

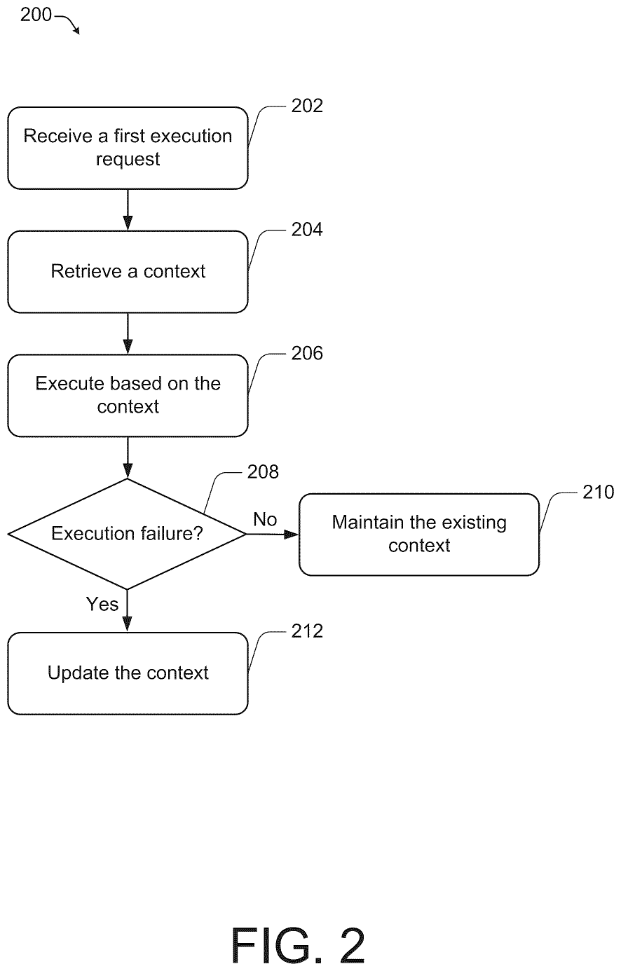

FIG. 2 is a flowchart diagram of an example process 200 for determining whether to update a context associated with a task type. As depicted in FIG. 2, at operation 202, process 200 includes receiving a first execution request associated with the task type. Examples of execution requests include an execution request for placing an order for a product, an execution request for generating a data reporting, an execution request for extracting data from a database, an execution request for initiating a scheduled backup process, an execution request for performing system one or more maintenance tasks, and an execution request for launching one or more software tests.

At operation 204, the process 200 includes retrieving a context associated with the first execution request. In some examples, after receiving the first execution request, the example system may retrieve a context associated with the task type corresponding to received request. For example, the context associated with an execution request with a “shipment tracking” task type may identify the tracking number, carrier information, and delivery status. In some examples, this context allows the system that executes the task corresponding to the “shipment tracking” task type to monitor and provide accurate updates on the shipment's progress.

At operation 206, the process 200 includes executing a task corresponding to the first execution request based on the retrieved context. In some examples, after retrieving the context associated with the execution request, the example system may obtain data needed to satisfy the requirements of the automation parameters identified by the context. Obtaining a data field may include at least one of: (i) providing a query to an end user and determining the data field based on a query response provided by the end user, or (ii) retrieving task data associated with the execution request and determine the data field based on the retrieved task data. In some examples, after obtaining the necessary data corresponding to automation parameters identified in a context, the example system proceeds to execute the task associated with the corresponding execution request.

At operation 208, the process 200 includes determining whether an execution outcome associated with execution of the task corresponding to the first execution request indicates an execution failure. The execution outcome may reflect the result of the execution operations and provide insights into the success or failure of those operations. In some examples, if the execution outcome represents that execution of the task failed, the example system determines that the execution outcome indicates an execution failure. In some examples, if the execution outcome represents that execution of the task failed because a requirement (e.g., a required data field or state) was missing, the example system determines that the execution outcome indicates an execution failure.

At operation 210, the process 200 includes maintaining the context associated with the first execution request based on (e.g., in response to) determining that the execution outcome does not indicate an execution failure. In some examples, if the execution outcome does not indicate an execution failure, the example system determines that the existing context includes all required automation parameters for executing the task and thus does not modify the context.

At operation 212, the process 200 includes updating the context associated with the first execution request based on (e.g., in response to) determining that the execution outcome indicates an execution failure. In some examples, if the execution outcome represents that the execution failed due to absence of an automation parameter, the example system may update the context associated with the request to add the automation parameter to the set of parameters identified by the context.

For example, if the execution outcome indicates that the execution of the task corresponding to a request failed due to absence of secondary authentication data (e.g., a two-factor authentication token), the system may update the context associated with the request to add an automation parameter that represents the secondary authentication data. As another example, if the execution outcome indicates that the execution of the task corresponding to a request failed due to absence of connection to a virtual private network, the system may update the context associated with the request to add an automation parameter that represents the operational state associated with connection to the virtual private network.

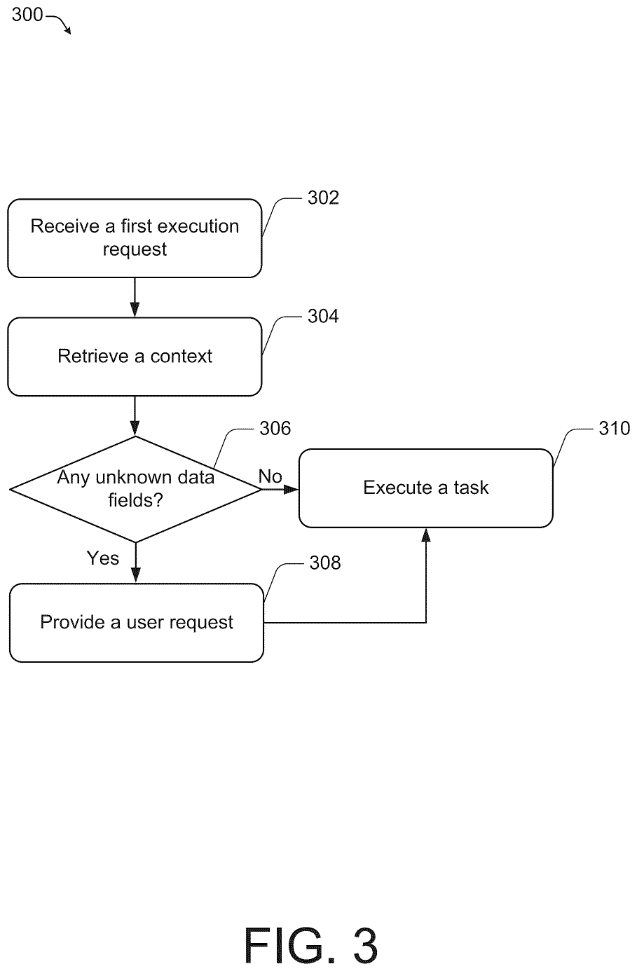

FIG. 3 is a flowchart diagram of an example process 300 for contextual execution of a computational task. As depicted in FIG. 3, at operation 302, the process 300 includes receiving a first execution request. In some examples, an execution request includes a specific instruction or command submitted to the example system that indicates a request to execute the task associated with a computational task. The execution request may identify relevant data needed for the system to execute the requested task accurately and efficiently.

At operation 304, the process 300 includes retrieving a context associated with the first execution request. In some examples, after receiving the first execution request, the example system may retrieve a context associated with the task type corresponding to received request. In some examples, the context associated with an execution request may identify one or more automation parameters associated with the request. An automation parameter may identify a data field or a system state needed before the system can successfully execute the task associated with the request in an automated way and without manual intervention.

At operation 306, the process 300 includes determining whether the values for all required data fields associated with the retrieved context can be determined based on the task data associated with the first execution request. In some examples, a data field is required by the context if at least one automation parameter identified by the context requires the data field.

For example, if an automation parameter requires providing a particular data field as part of executing the task corresponding to the first execution request, then the particular data field may be a required data field for the first execution request. As another example, if an automation parameter requires triggering a particular system state and triggering the particular system requires providing a particular data field, then the particular data field may be a required data field for the first execution request. In some cases, the example system can use an automation parameter that defines an execution agent (e.g., an employee) for executing a manual task associated with an execution task to determine an expected completion time associated with the execution task. For example, the example system may determine that expected completion time based on historical data associated with the execution agent (e.g., based on prior turn-around times associated with an employee).

At operation 308, the process 300 includes providing a request to an end user to provide a required data field that cannot be determined based on the task data associated with the first execution request based on (e.g., in response to) determining that at least one value for a required data field cannot be determined based on the task data associated with the first execution request. In some examples, when the system identifies an automation parameter that requires specific data from the user, the system formulates a query, often in the form of a prompt or a set of questions. The system may then present the query to the user, who can provide the relevant information needed to satisfy the parameter's requirements. For example, if an automation parameter requires the recipient's email addresses for an email campaign, the system may generate a query asking the user to input the email addresses of the intended recipients. The user can then respond by entering the required data.

At operation 310, the process 300 includes executing the task corresponding to the first execution request: (i) based on (e.g., in response to) determining that the values for all required data fields associated with the retrieved context can be determined based on the task data associated with the first execution request, or (ii) after providing a request to an end user to provide a required data field that cannot be determined based on the task data associated with the first execution request.

In some examples, based on determining that all required data fields associated with the retrieved context can be determined based on the task data associated with the first execution request, the example system may determine values for the required data fields based on the task data and execute the task based on the determined values. In some examples, based on determining that at least one required data field cannot be determined based on the task data associated with the first execution request, the example system may: (i) determine values for any required data fields whose respective values cannot be determined based on task data using user-provided responses, and (ii) execute the task based on the determined values.

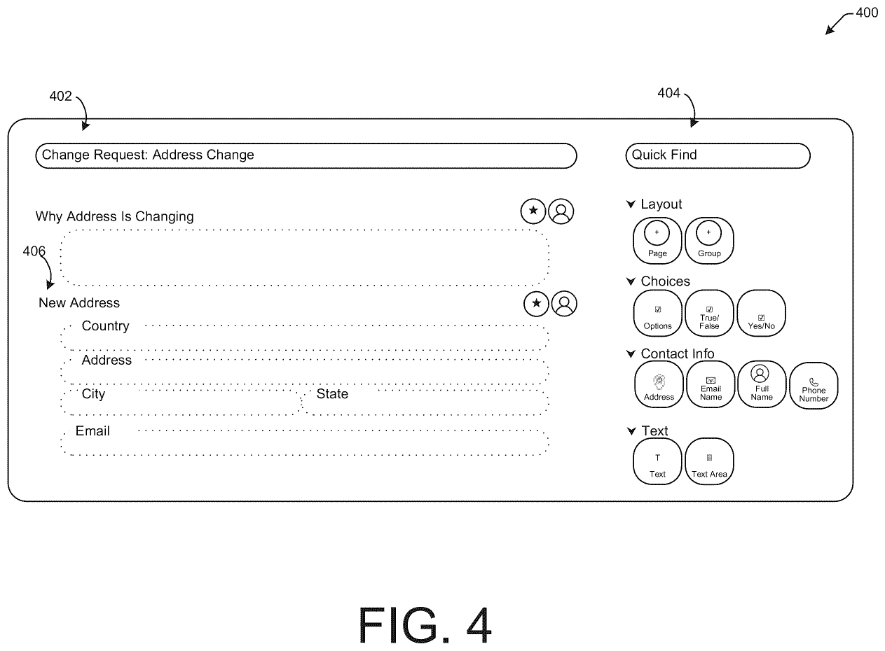

FIG. 4 provides an operational example of a data form creation platform 400 that has been used to create a data entry form 402. As depicted in FIG. 4, the data form creation platform 400 includes the data form creation toolbox 404 that includes: (i) a tool to create a new page in a data form, (ii) a tool to create a new group of data form elements (e.g., the group 406), (iii) tools to create input-receiving form elements configured to receive user inputs having a yes/no format, a true/false format, or a multiple-choice selection format, (iv) tools to create input-receiving form elements configured to receive user inputs having an address format, an email name format, a full name format, or a phone number format, (v) a tool to create an input-receiving form element configured to a user input having a freeform text format, and (vi) a tool to add text segments to a data form.

As further depicted in FIG. 4, a developer has used the data form creation toolbox 404 to create the data entry form 402. The data entry form 402 is an address change request form with a field that is configured to receive the reason for address change as well as fields that receive elements of the user's new address and email address.

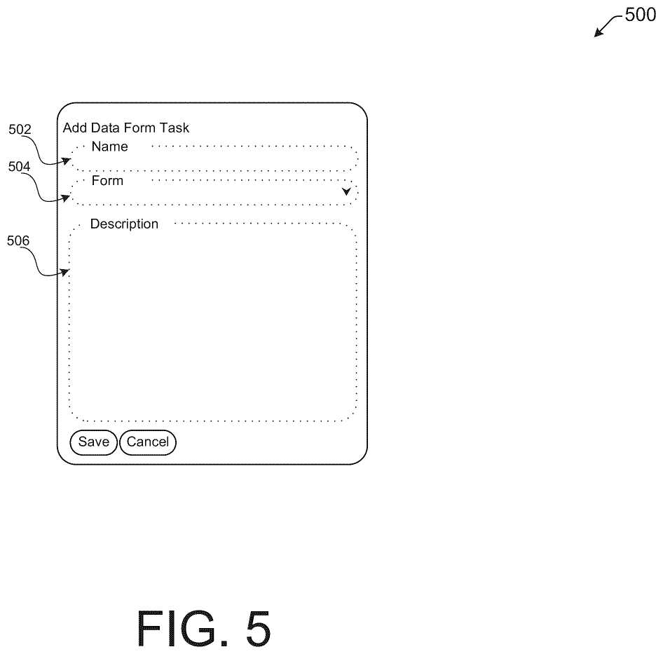

FIG. 5 provides an operation example of a task creation platform 500 that can be used to receive an execution request from a user and identify the task type for the received request. As depicted in FIG. 5, the task creation platform 500 includes a field 502 that receives a nominal identifier associated with the received request, a field 504 that receives a data entry form associated with the received request, and a field 506 that receives textual description data associated with the received request. In some examples, the task type of the resulting task is a “data form distribution” type related to distribution of the data entry form identified in the field 504. For example, if the user provides an indication of the address change request form in the field 504, the task type of the resulting task is an address change request form distribution type.

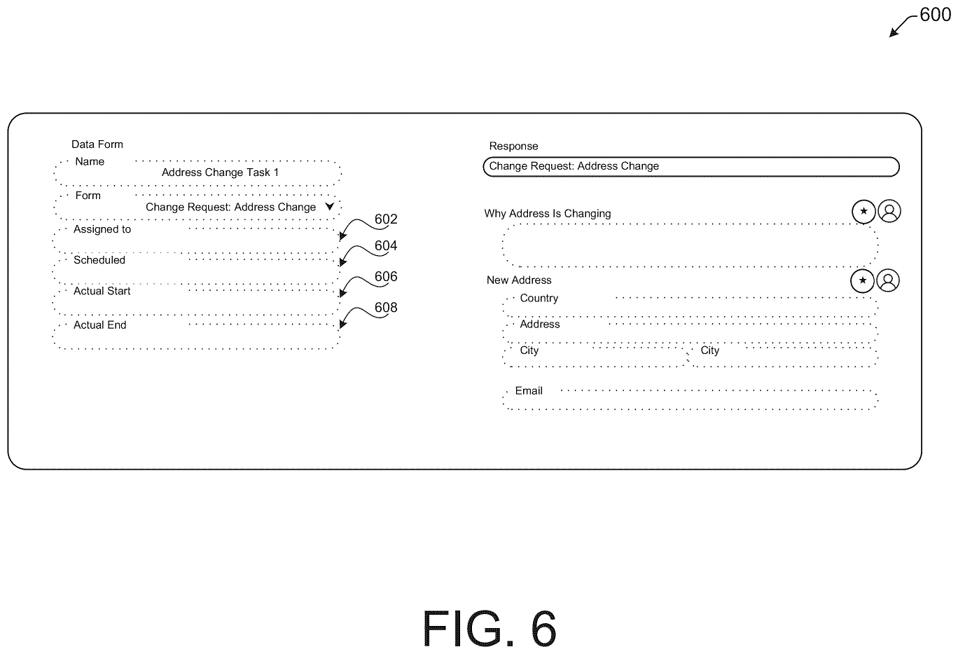

FIG. 6 provides an operational example of a data entry platform 600 that enables a user to provide values corresponding to automation parameters of an execution task associated with distribution of an address change request form. As depicted in FIG. 6, the data entry platform 600 includes data fields 602, 604, 606, and 608 that are configured to receive user inputs corresponding to values for automation parameters of the execution task.

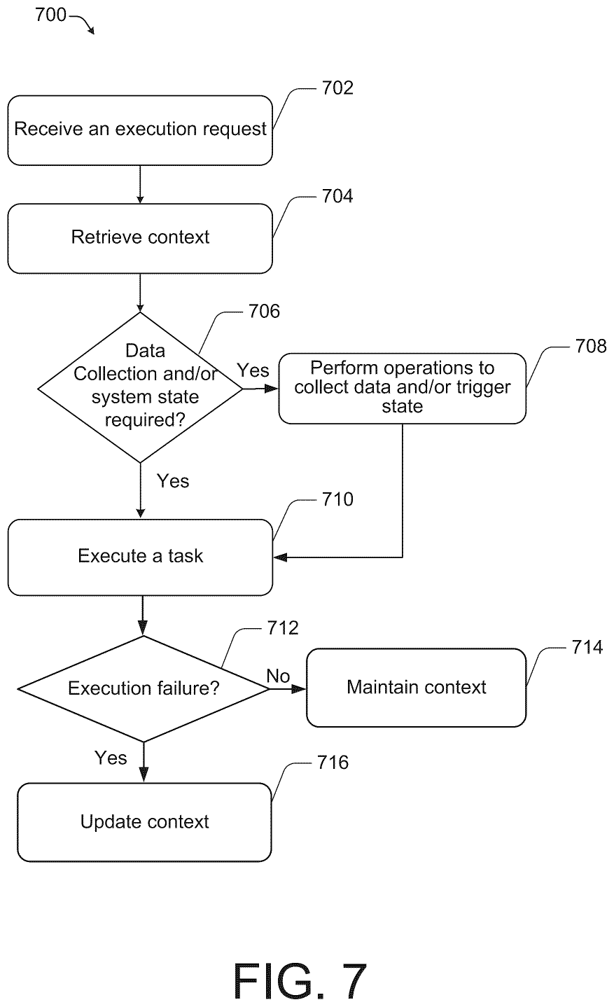

FIG. 7 is a flowchart diagram of an example process 700 for dynamically updating context of an execution request over time. As depicted in FIG. 7, at operation 702, process 700 includes receiving a first execution request. Examples of execution requests include an execution request for placing an order for a product, an execution request for generating a data reporting, an execution request for extracting data from a database, an execution request for initiating a scheduled backup process, an execution request for performing system one or more maintenance tasks, and an execution request for launching one or more software tests.

At operation 704, process 700 includes retrieving context data associated with the first execution request. In some examples, after receiving the execution request, the example system may retrieve a context associated with the task type corresponding to received request. In some examples, the context associated with an execution task represents one or more requirements associated with automatic execution of task.

At operation 706, the process 700 includes determining whether the context associated with the first execution request requires collecting one or more data fields and/or trigger a particular system state. If the example system determines that the context associated with the first execution request requires collecting one or more data fields and/or trigger a particular system state, at operation 708, the process 700 includes performing operations configured to collect the data fields and/or trigger the particular system state.

At operation 710, the process 700 includes executing a task corresponding to the first execution request based on the retrieved context. In some examples, after obtaining the necessary data corresponding to automation parameters identified in the context and/or after performing operations required to trigger a system identified in the context, the example system proceeds to execute the task associated with the corresponding execution request.

At operation 712, the process 700 includes determining whether an execution outcome associated with execution of the task corresponding to the first execution request indicates an execution failure. In some examples, if the execution outcome represents that execution of the task failed, the example system determines that the execution outcome indicates an execution failure. In some examples, if the execution outcome represents that execution of the task failed because a requirement (e.g., a required data field or state) was missing, the example system determines that the execution outcome indicates an execution failure.

At operation 714, the process 700 includes maintaining the context associated with the first execution request based on (e.g., in response to) determining that the execution outcome does not indicate an execution failure. In some examples, if the execution outcome does not indicate an execution failure, the example system determines that the existing context includes all required automation parameters for executing the task and thus does not modify the context.

At operation 716, the process 700 includes updating the context associated with the first execution request based on (e.g., in response to) determining that the execution outcome indicates an execution failure. In some examples, if the execution outcome represents that the execution failed due to absence of an automation parameter, the example system may update the context associated with the request to add the automation parameter to the set of parameters identified by the context.

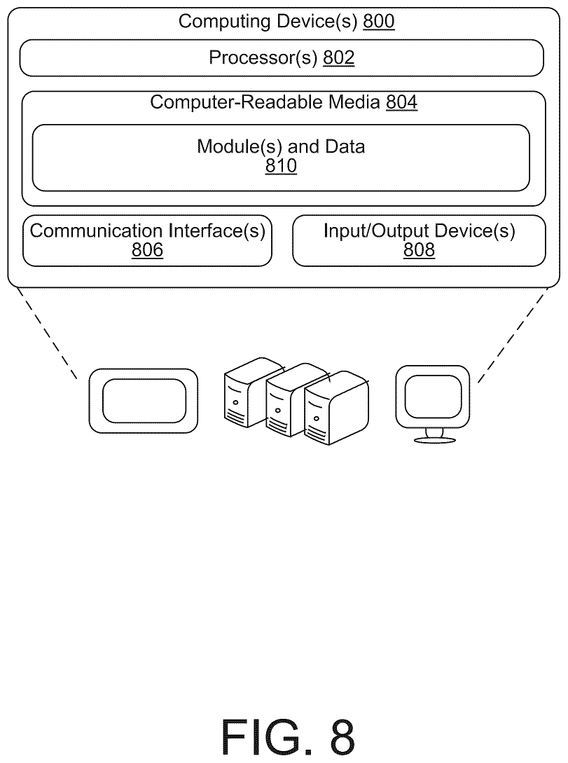

FIG. 8 illustrates example computing device(s) 800 for performing techniques described herein. The computing device(s) 800 can comprise user device(s) including, but not limited to, mobile phone(s), personal digital assistant(s), netbook(s), laptop computer(s), desktop computer(s), networked computer(s), and/or any another electronic device(s) that are capable of transmitting or receiving data), server computing device(s). In some examples, the computing device(s) 800 can comprise server computing device(s) (e.g., server(s)), which can be any type of server, such as a network-accessible server. In some examples, the server(s) can be stand-alone computing systems, distributed-computing systems, networked-computing systems, etc. For instance, in at least one example, one or more of the functionalities described herein as being performed by the server(s) can be performed by a single device or multiple devices. In some examples, one or more of the functionalities described herein can be performed one or more remotely located devices instead of, or in addition to, the server(s).

In at least one example, the computing device(s) 800 can include processor(s) 802, computer-readable media 804, communication interface(s) 806, and input/output device(s) 808.

The processor(s) 802 can represent, for example, a central processing unit (CPU)-type processing unit, a graphics processing unit (GPU)-type processing unit, a Field-Programmable Gate Array (FPGA), another class of Digital Signal Processor (DSP), or other hardware logic components that can, in some instances, be driven by a CPU. For example, and without limitation, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), etc. In at least one example, an accelerator can represent a hybrid device, such as one from ZYLEX or ALTERA that includes a CPU course embedded in an FPGA fabric. In various embodiments, the processor(s) 802 can execute one or more modules and/or processes to cause the computing device(s) 800 to perform a variety of functionalities, as set forth above and explained in further detail in the following disclosure. Additionally, each of the processor(s) 802 can possess its own local memory, which also can store program modules, program data, and/or one or more operating systems.

Computer-readable media 804 includes computer-readable storage media and communication media. Computer-readable storage media can include volatile memory, nonvolatile memory, and/or other persistent and/or auxiliary computer-readable storage media, removable and non-removable computer-readable storage media implemented in any method or technology for storage of data such as computer readable instructions, data structures, program modules, or other data. Computer memory is an example of computer-readable storage media. Thus, computer-readable storage media includes tangible and/or physical forms of media included in a device and/or hardware component that is part of a device or external to a device, including but not limited to random-access memory (RAM), static random-access memory (SRAM), dynamic random-access memory (DRAM), phase change memory (PRAM), read-only memory (ROM), erasable programmable read-only memory (EPROM), electrically erasable programmable read-only memory (EEPROM), flash memory, compact disc read-only memory (CD-ROM), digital versatile discs (DVDs), optical cards or other optical storage media, miniature hard drives, memory cards, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain data for access by a computing device.

In at least one example, the computer-readable storage media can include non-transitory computer-readable media. Non-transitory computer-readable storage media can include volatile and nonvolatile, removable and non-removable tangible, physical media implemented in technology for storage of data, such as computer readable instructions, data structures, program modules, or other data. Non-transitory computer-readable media include, but are not limited to, RAM, ROM, EEPROM, flash memory or other memory technology, CD-ROM, DVDs or other optical storage, magnetic cassettes, magnetic tape, magnetic disk storage or other magnetic storage devices, or any other tangible, physical medium which can be used to store the desired data and which can be accessed by the computing device(s) 800. Any such non-transitory computer-readable media can be part of the computing device(s) 800.

In contrast, communication media includes computer readable instructions, data structures, program modules, or other data in a modulated data signal, such as a carrier wave, or other transmission mechanism. As defined herein, computer-readable storage media does not include communication media.

In at least one example, the computer-readable media 804 can store module(s) and data 810. The module(s) and data 810 can be in the form of stand-alone applications, productivity applications, an operating system component, or any other application or software module.

The communication interface(s) 806 can include one or more interfaces and hardware components for enabling communication with various other devices, such as over network(s) or directly. For example, communication interface(s) 806 can enable communication through one or more networks, which can include, but are not limited any type of network known in the art, such as a local area network or a wide area network, such as the Internet, and can include a wireless network, such as a cellular network, a cloud network, a local wireless network, such as Wi-Fi and/or close-range wireless communications, such as Bluetooth®, BLE, NFC, RFID, a wired network, low power area networks (LPWAN) or any other such network, or any combination thereof. Components used for such communications can depend at least in part upon the type of network, the environment selected, or both. Protocols for communicating over such networks are well known and will not be discussed herein in detail.

In at least one example, the one or more input/output (I/O) devices 808 can include speakers, a microphone, a camera, a display, a haptic output device, various user controls (e.g., buttons, a joystick, a keyboard, a keypad, etc.), and so forth.

### CONCLUSION

While one or more examples of the techniques described herein have been described, various alterations, additions, permutations and equivalents thereof are included within the scope of the techniques described herein. As can be understood, the components discussed herein are described as divided for illustrative purposes. However, the operations performed by the various components can be combined or performed in any other component. It should also be understood that components or steps discussed with respect to one example or implementation can be used in conjunction with components or steps of other examples. For example, the components and instructions of FIG. 8 can implement and/or utilize the processes and flows of FIGS. 1-7.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some examples the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

Although the subject matter has been described in language specific to structural data items and/or methodological acts, it is to be understood that the subject matter defined in the appended claims is not necessarily limited to the specific data items or acts described. Rather, the specific data items and acts are disclosed as example forms of implementing the claims.

### EXAMPLE CLAUSES

While the example clauses described below are described with respect to one particular implementations, it should be understood that, in the context of this document, the content of the example clauses can also be implemented via a method, device, system, computer-readable medium, and/or another implementation. Additionally, any of example clauses A-W can be implemented alone or in combination with any other one or more of the examples A-W.

A. A system comprising: a processor; and a computer-readable medium storing computer-executable instructions that, when executed, cause the processor perform operations comprising: receiving a first execution request associated with a first task type, wherein the first task type is associated with a context that represents a first automation parameter; providing, based on the context, a first data request to obtain a first value associated with the first automation parameter; automatically executing a first task associated with the first task type based on the first value to determine a first execution outcome; determining, based on the first execution outcome, an execution failure associated with a second automation parameter; determining an updated context associated with the first task type, wherein the updated context represents the first automation parameter and the second automation parameter; receiving a second execution request associated with the first task type; determining, based on the updated context, a second data request to obtain a second value associated with the first automation parameter and a third value associated with the second automation parameter; and automatically executing a second task associated with the first task type based on the first value and the second value.

B. The system of clause A, wherein: the second value defines a data access platform associated with a data retrieval operation associated with the second task, and the third value defines an access credential configured to provide access to the data access platform.

C. The system of clause A, wherein: the second value defines a first automated operation associated with the second task, and the third value defines a failsafe operation to execute subsequent to detecting failure of execution of the first automated operation.

D. The system of any one or more of clauses A-C, the operations further comprising: determining, based on the context, a data retrieval operation associated with the first task type; determining, based on the first execution outcome, a post-retrieval processing requirement associated with the first task, wherein the post-retrieval processing requirement defines at least one of a format modification requirement or a data validation requirement; determining the updated context to represent a post-retrieval processing operation corresponding to the post-retrieval processing requirement; and automatically executing the second task by performing the post-retrieval processing operation subsequent to the data retrieval operation.

E. The system of any one or more of clauses A-D, the operations further comprising: determining, based on the execution failure, a prerequisite condition associated with the first task type; determining the updated context based on the prerequisite condition; and automatically executing the second task based on determining that the prerequisite condition is satisfied.

F. A computer-readable medium storing instructions executable by a processor, wherein the instructions, when executed, configure the processor to perform operations comprising to: receive a first execution request associated with a first task type, wherein the first task type is associated with a context that represents a first automation parameter, and wherein the first automation parameter defines at least one of: (i) a first feature associated with a data retrieval operation of the first task type, or (ii) a second feature associated with a post-retrieval operation of the first task type; provide, based on the context, a first data request to obtain a first value associated with the first automation parameter; and automatically executing a first task associated with the first task type based on the first value.

G. The computer-readable medium of clause F, wherein: the data retrieval operation includes to transmit a data collection form to a recipient; the first feature represents a data field associated with the data collection form; and the second feature represents a data validation operation associated with the data field.

H. The computer-readable medium of clause F or G, the operations further comprising to: determine a first execution outcome associated with execution of the first task; determine, based on the first execution outcome, an execution failure associated with a second automation parameter; determine an updated context associated with the first task type, wherein the updated context represents the first automation parameter and the second automation parameter; receiving a second execution request associated with the first task type; providing, based on the updated context, a second data request to obtain a second value associated with the first automation parameter and a third value associated with the second automation parameter; and automatically execute a second task associated with the first task type based on the first value and the second value.

I. The computer-readable medium of any one or more of clauses F-H, the operations further comprising to: determine, based on the context, a data retrieval operation associated with the first task type; determine, based on the first execution outcome, a post-retrieval processing requirement associated with the first task, wherein the post-retrieval processing requirement defines at least one of a format modification requirement or a data validation requirement; determine the updated context to represent a post-retrieval processing operation corresponding to the post-retrieval processing requirement; and automatically execute the second task by performing the post-retrieval processing operation subsequent to the data retrieval operation.

J. The computer-readable medium of any one or more of clauses F-I, the operations further comprising to: determine, based on the execution failure, a prerequisite condition associated with the first task type; determine the updated context based on the prerequisite condition; and automatically execute the second task based on determining that the prerequisite condition is satisfied.

K. The computer-readable medium of any one or more of clauses F-J, wherein the first automation parameter relates to at least one of: a data access platform to facilitate a data retrieval operation associated with the first task, or an access credential configured to provide access to the data access platform.

L. The computer-readable medium of any one or more of clauses F-K, wherein the first automation parameter relates to at least one of: a first automated operation, or a failsafe operation to execute subsequent to detecting failure of execution of the first automated operation.

M. The computer-readable medium of any one or more of clauses F-L, the operations further comprising to: determine, based on the context, a second automation parameter that relates to a third feature associated with a prerequisite condition of the first task type, wherein the third feature defines a manual task; determining a second value of the second automation parameter that defines an execution agent to execute the manual task; and determine, based on historical data associated with the execution agent, an expected completion time associated with the first task.

N. A system comprising: a processor; and a computer-readable medium as any one or more of clauses F-M recites.

O. A method comprising: receiving a first execution request associated with a first task type, wherein the first task type is associated with a context that represents a first automation parameter, and wherein the first automation parameter defines at least one of: (i) a first feature associated with a data retrieval operation of the first task type, or (ii) a second feature associated with a post-retrieval operation of the first task type; providing, based on the context, a first data request to obtain a first value associated with the first automation parameter; and automatically executing a first task associated with the first task type based on the first value.

P. The method of clause O, wherein: the data retrieval operation comprises transmitting a data collection form to a recipient; the first feature represents a data field associated with the data collection form; and the second feature represents a data validation operation associated with the data field.

Q. The method of clause O or P, further comprising: determining a first execution outcome associated with execution of the first task; determining, based on the first execution outcome, an execution failure associated with a second automation parameter; determining an updated context associated with the first task type, wherein the updated context represents the first automation parameter and the second automation parameter; receiving a second execution request associated with the first task type; providing, based on the updated context, a second data request to obtain a second value of the first automation parameter and a third value of the second automation parameter; and automatically executing a second task associated with the first task type based on the first value and the second value.

R. The method of any one or more of clauses O-Q, further comprising: determining, based on the context, a data retrieval operation associated with the first task type; determining, based on the first execution outcome, a post-retrieval processing requirement associated with the first task, wherein the post-retrieval processing requirement defines at least one of a format modification requirement or a data validation requirement; determining the updated context to represent a post-retrieval processing operation corresponding to the post-retrieval processing requirement; and automatically executing the second task by performing the post-retrieval processing operation subsequent to the data retrieval operation.

S. The method of any one or more of clauses O-R, wherein the first automation parameter relates to at least one of: a data access platform to facilitate a data retrieval operation associated with the first task, or an access credential configured to provide access to the data access platform.

T. The method of any one or more of clauses O-S, wherein the first automation parameter relates to at least one of: a first automated operation, or a failsafe operation to execute subsequent to detecting failure of execution of the first automated operation.

U. The method of any one or more of clauses O-T, further comprising: determining, based on the context, a second automation parameter that relates to a third feature associated with a prerequisite condition associated with the first task type, wherein the third feature defines a manual task; determining a second value associated with the second automation parameter that defines an execution agent to execute the manual task; and determining, based on historical data associated with the execution agent, an expected completion time associated with the first task.

V. A computer-readable medium storing instructions executable by a processor, wherein the instructions, when executed, configure the processor to perform a method as any one of more of clauses O-U recites.

W. A system comprising: a processor, and a computer-readable medium storing instructions executable by a processor, wherein the instructions, when executed, configure the processor to perform a method as any one of more of clauses O-U recites.

What is claimed is:

1. A system comprising:
a processor; and
a computer-readable medium storing computer-executable instructions that, when executed, cause the processor perform operations comprising:
receiving a first execution request associated with a first task type, wherein the first task type is associated with a context that represents a first automation parameter;
providing, based on the context, a first data request to obtain a first value associated with the first automation parameter;
automatically executing a first task associated with the first task type based on the first value to determine a first execution outcome;
determining, based on the first execution outcome, an execution failure associated with a second automation parameter;
determining an updated context associated with the first task type, wherein the updated context represents the first automation parameter and the second automation parameter;
receiving a second execution request associated with the first task type;
determining, based on the updated context, a second data request to obtain a second value associated with the first automation parameter and a third value associated with the second automation parameter; and
automatically executing a second task associated with the first task type based on the first value and the second value.

2. The system of claim 1, wherein:
the second value defines a data access platform associated with a data retrieval operation associated with the second task, and
the third value defines an access credential configured to provide access to the data access platform.

3. The system of claim 1, wherein:
the second value defines a first automated operation associated with the second task, and
the third value defines a failsafe operation to execute subsequent to detecting failure of execution of the first automated operation.

4. The system of claim 1, the operations further comprising:
determining, based on the context, a data retrieval operation associated with the first task type;
determining, based on the first execution outcome, a post-retrieval processing requirement associated with the first task, wherein the post-retrieval processing requirement defines at least one of a format modification requirement or a data validation requirement;
determining the updated context to represent a post-retrieval processing operation corresponding to the post-retrieval processing requirement; and
automatically executing the second task by performing the post-retrieval processing operation subsequent to the data retrieval operation.

5. The system of claim 1, the operations further comprising:
determining, based on the execution failure, a prerequisite condition associated with the first task type;
determining the updated context based on the prerequisite condition; and
automatically executing the second task based on determining that the prerequisite condition is satisfied.

6. A computer-readable medium storing instructions executable by a processor, wherein the instructions, when executed, cause the processor to perform operations comprising:
receiving a first execution request associated with a first task type, wherein the first task type is associated with a context that represents a first automation parameter, and wherein the first automation parameter defines at least one of: (i) a first feature associated with a data retrieval operation of the first task type, or (ii) a second feature associated with a post-retrieval operation of the first task type;
providing, based on the context, a first data request to obtain a first value associated with the first automation parameter; and
automatically executing a first task associated with the first task type based on the first value.

7. The computer-readable medium of claim 6, wherein:
the data retrieval operation comprises transmitting a data collection form to a recipient;
the first feature represents a data field associated with the data collection form; and
the second feature represents a data validation operation associated with the data field.

8. The computer-readable medium of claim 6, the operations further comprising:
determining a first execution outcome associated with execution of the first task;
determining, based on the first execution outcome, an execution failure associated with a second automation parameter;
determining an updated context associated with the first task type, wherein the updated context represents the first automation parameter and the second automation parameter;
receiving a second execution request associated with the first task type;
providing, based on the updated context, a second data request to obtain a second value associated with the first automation parameter and a third value associated with the second automation parameter; and
automatically executing a second task associated with the first task type based on the first value and the second value.

9. The computer-readable medium of claim 8, the operations further comprising:
determining, based on the context, a data retrieval operation associated with the first task type;
determining, based on the first execution outcome, a post-retrieval processing requirement associated with the first task, wherein the post-retrieval processing requirement defines at least one of a format modification requirement or a data validation requirement;
determining the updated context to represent a post-retrieval processing operation corresponding to the post-retrieval processing requirement; and
automatically executing the second task by performing the post-retrieval processing operation subsequent to the data retrieval operation.

10. The computer-readable medium of claim 8, the operations further comprising:
determining, based on the execution failure, a prerequisite condition associated with the first task type;
determining the updated context based on the prerequisite condition; and
automatically executing the second task based on determining that the prerequisite condition is satisfied.

11. The computer-readable medium of claim 6, wherein the first automation parameter relates to at least one of:
a data access platform to facilitate a data retrieval operation associated with the first task, or
an access credential configured to provide access to the data access platform.

12. The computer-readable medium of claim 6, wherein the first automation parameter relates to at least one of:
a first automated operation, or
a failsafe operation to execute subsequent to detecting failure of execution of the first automated operation.

13. The computer-readable medium of claim 6, the operations further comprising:
determining, based on the context, a second automation parameter that relates to a third feature associated with a prerequisite condition of the first task type, wherein the third feature defines a manual task;
determining a second value of the second automation parameter that defines an execution agent to execute the manual task; and
determining, based on historical data associated with the execution agent, an expected completion time associated with the first task.

14. A method comprising:
receiving a first execution request associated with a first task type, wherein the first task type is associated with a context that represents a first automation parameter, and wherein the first automation parameter defines at least one of: (i) a first feature associated with a data retrieval operation of the first task type, or (ii) a second feature associated with a post-retrieval operation of the first task type;
providing, based on the context, a first data request to obtain a first value associated with the first automation parameter; and
automatically executing a first task associated with the first task type based on the first value.

15. The method of claim 14, wherein:
the data retrieval operation comprises transmitting a data collection form to a recipient;
the first feature represents a data field associated with the data collection form; and
the second feature represents a data validation operation associated with the data field.

16. The method of claim 14, further comprising:
determining a first execution outcome associated with execution of the first task;
determining, based on the first execution outcome, an execution failure associated with a second automation parameter;
determining an updated context associated with the first task type, wherein the updated context represents the first automation parameter and the second automation parameter;
receiving a second execution request associated with the first task type;
providing, based on the updated context, a second data request to obtain a second value of the first automation parameter and a third value of the second automation parameter; and
automatically executing a second task associated with the first task type based on the first value and the second value.

17. The method of claim 16, further comprising:
determining, based on the context, a data retrieval operation associated with the first task type;
determining, based on the first execution outcome, a post-retrieval processing requirement associated with the first task, wherein the post-retrieval processing requirement defines at least one of a format modification requirement or a data validation requirement;
determining the updated context to represent a post-retrieval processing operation corresponding to the post-retrieval processing requirement; and
automatically executing the second task by performing the post-retrieval processing operation subsequent to the data retrieval operation.

18. The method of claim 14, wherein the first automation parameter relates to at least one of:
a data access platform to facilitate a data retrieval operation associated with the first task, or
an access credential configured to provide access to the data access platform.

19. The method of claim 14 wherein the first automation parameter relates to at least one of:
a first automated operation, or
a failsafe operation to execute subsequent to detecting failure of execution of the first automated operation.

20. The method of claim 14, further comprising:
determining, based on the context, a second automation parameter that relates to a third feature associated with a prerequisite condition associated with the first task type, wherein the third feature defines a manual task;
determining a second value associated with the second automation parameter that defines an execution agent to execute the manual task; and
determining, based on historical data associated with the execution agent, an expected completion time associated with the first task.
